(19) United States
(12) Patent Application Publication
(10) Pub. No.: US 2026/0202194 A1
(43) Pub. Date: Jul. 16, 2026

(54) IMAGE ACQUIRING DEVICE, AND IMAGE ACQUIRING METHOD

(71) Applicant: Mitsubishi Electric Corporation, Tokyo (JP)

(72) Inventors: Wataru Yoshiki, Tokyo (JP); Masaharu Imaki, Tokyo (JP); Takao Endo, Tokyo (JP)

(73) Assignee: Mitsubishi Electric Corporation, Tokyo (JP)

(21) Appl. No.: 19/561,169

(22) Filed: Mar. 9, 2026

Related U.S. Application Data
(63) Continuation of application No. PCT/JP2023/040320, filed on Nov. 9, 2023.

(51) Int. Cl. G01B 11/25; G06T 3/40; G06T 7/00

(52) U.S. Cl. CPC G01B 11/254; G06T 3/40; G06T 7/0002

(57) ABSTRACT

An image acquiring device includes processing circuitry configured to: output an illumination pattern that is a pattern formed with sections of different sizes for regions among a plurality of regions arranged in one direction; receive light from a measurement target irradiated with the illumination pattern having been output, via a single-pixel photodetector; and acquire a reception signal based on the received light, and generate a two-dimensional image of the measurement target for each of the regions on a basis of a change in the acquired reception signal, and in each of the regions in the illumination pattern, the plurality of regions having the sections of different sizes is arranged in such a manner as to be aligned in a direction from a large section region to a small section region in a direction in which the measurement target moves.

### CROSS REFERENCE TO RELATED APPLICATION

This application is a Continuation of PCT International Application No. PCT/JP 2023/040320, filed on Nov. 9, 2023, which is hereby expressly incorporated by reference into the present application.

### TECHNICAL FIELD

The technology according to the present disclosure relates to an image acquiring technology for acquiring an image of a measurement target by irradiating the measurement target with an illumination pattern formed with a two-dimensional pattern.

### BACKGROUND ART

Among image acquiring technologies, there is a technology called single pixel imaging (SPI). In SPI, a measurement target is irradiated with a large number of two-dimensional illumination patterns, and reflected light and/or scattered light from the measurement target is recorded with a single-pixel detector. The illuminating two-dimensional pattern is associated with the reception signal intensity, and signal processing is performed on the information, so that a two-dimensional image of the measurement target can be acquired even though only a single-pixel detector is used. SPI is a technology particularly useful in a wavelength band in which a two-dimensional array detector is expensive or difficult to form, but, on the other hand, to generate a large number of two-dimensional patterns, requires a spatial light modulator capable of dynamically controlling display patterns, such as a digital micromirror device (DMD).

On the other hand, Non-Patent Literature 1 discloses a technology for acquiring a two-dimensional image of a measurement target by simply irradiating the measurement target moving at a constant speed with a single illumination pattern. As the measurement target moves at a constant speed, the positional relationship between the measurement target and the illumination pattern changes. As a result, an apparent illumination pattern (hereinafter also referred to as an illumination frame) with which the measurement target is irradiated changes, and thus, a two-dimensional image can be acquired on the same principle as that of general SPI. In this configuration, a single illumination pattern is sufficient. Therefore, there is no need to dynamically change the illumination pattern, and a spatial light modulator such as a DMD is unnecessary.

### CITATION LIST

### Non-Patent Literature

Non-Patent Literature 1: Ota et al., Science 360, 1246-1251 (2018)

### SUMMARY OF INVENTION

### Technical Problem

In the configuration disclosed in Non-Patent Literature 1, however, the number of apparent illumination patterns (illumination frames) is proportional to the distance the measurement target moves on the illumination pattern. Therefore, when the configuration disclosed in Non-Patent Literature 1 is adopted in an image inspection for an object flowing on a belt conveyor, for example, there is a problem in that a sufficiently accurate image is acquired only after the measurement target moves a long distance on the illumination pattern, and the measurement time required for one measurement target becomes longer.

The present disclosure is to solve the above problem, and aims to be able to shorten the measurement time required for one measurement target in a case where a measurement target is measured with a two-dimensional image by the SPI technology for obtaining the two-dimensional image of a measurement target using a single illumination pattern.

### Solution to Problem

An image acquiring device for acquiring an image of a measurement target moving at a constant speed according to the present disclosure includes: processing circuitry configured to: output an illumination pattern that is a pattern formed with sections of different sizes for regions among a plurality of regions arranged in one direction; receive light from the measurement target irradiated with the illumination pattern having been output, via a single-pixel photodetector; and acquire a reception signal based on the received light, and generate a two-dimensional image of the measurement target for each of the regions on a basis of a change in the acquired reception signal, wherein, in each of the regions in the illumination pattern, the plurality of regions having the sections of different sizes is arranged in such a manner as to be aligned in a direction from a large section region to a small section region in a direction in which the measurement target moves.

### Advantageous Effects of Invention

According to the present disclosure, the measurement time required for one measurement target can be effectively shortened in a case where a measurement target is measured with a two-dimensional image by the SPI technology for obtaining the two-dimensional image of a measurement target using a single illumination pattern.

### BRIEF DESCRIPTION OF DRAWINGS

FIG. 1 is a diagram illustrating an example of a basic configuration of an image acquiring device 100 according to a first embodiment of the present disclosure.

FIG. 2 is a flowchart illustrating an example of a basic operation to be performed by the image acquiring device 100 according to the first embodiment of the present disclosure.

FIG. 3 is a diagram illustrating an example configuration of an image acquiring device 100A according to a second embodiment of the present disclosure, and an example configuration in a case where the image acquiring device 100A is adopted in a measurement system.

FIG. 4 is a diagram illustrating a first example of an illumination pattern to be irradiated by an illuminating system unit 110A in the image acquiring device 100A according to the second embodiment of the present disclosure.

FIG. 5 is a diagram illustrating a second example of the illumination pattern to be irradiated by the illuminating system unit 110A in the image acquiring device 100A according to the second embodiment of the present disclosure.

FIG. 6 is a diagram illustrating an example configuration of the illuminating system unit 110A in the image acquiring device 100A according to the second embodiment of the present disclosure.

FIG. 7 is a diagram illustrating an example configuration of a signal processing unit 150A in the image acquiring device 100A according to the second embodiment of the present disclosure.

FIG. 8 is a flowchart illustrating an example process to be performed by the signal processing unit 150A in the image acquiring device 100A according to the second embodiment of the present disclosure.

FIG. 9 is a flowchart illustrating an example operation to be performed in the image acquiring device 100A according to the second embodiment of the present disclosure.

FIG. 10 is a diagram for explaining an operation related to acquisition of a reception signal in the image acquiring device 100A according to the second embodiment of the present disclosure.

FIG. 11 is a diagram for explaining a first image reconstructing process related to the signal processing unit 150A in the image acquiring device 100A according to the second embodiment of the present disclosure.

FIG. 12 is a diagram for explaining a second image reconstructing process related to the signal processing unit 150A in the image acquiring device 100A according to the second embodiment of the present disclosure.

FIG. 13 is a diagram illustrating a first example of a hardware configuration for achieving the functions of a configuration according to the present disclosure.

FIG. 14 is a diagram illustrating a second example of a hardware configuration for achieving the functions of a configuration according to the present disclosure.

### DESCRIPTION OF EMBODIMENTS

An image acquiring device of the present disclosure utilizes the SPI technology to obtain a two-dimensional image of a measurement target by irradiating the measurement target with a two-dimensional pattern, and capturing reflection and scattering of illuminating light from the measurement target with a single-pixel detector.

To explain the present disclosure in greater detail, embodiments of the disclosure are described below with reference to the accompanying drawings.

### First Embodiment

In a first embodiment, a basic mode of the present disclosure is described.

### Configuration

An example configuration of an image acquiring device according to the first embodiment of the present disclosure is described.

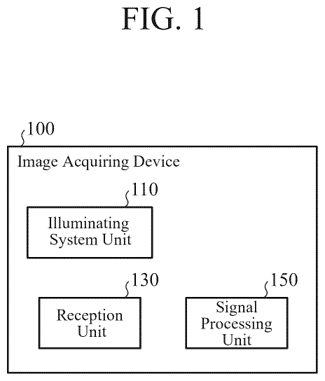

FIG. 1 is a diagram illustrating an example of a basic configuration of an image acquiring device 100 according to the first embodiment of the present disclosure. The image acquiring device 100 outputs an illumination pattern that is a pattern formed with sections of different sizes for the respective regions of a plurality of regions arranged in one direction, receives light from a measurement target irradiated with the output illumination pattern via a single-pixel photodetector, acquires a reception signal based on the received light, and generates a two-dimensional image of the measurement target for each of the regions on the basis of a change in the acquired reception signal.

The image acquiring device 100 illustrated in FIG. 1 includes an illuminating system unit 110, a reception unit 130, and a signal processing unit 150. The illuminating system unit 110 outputs an illumination pattern that is a pattern formed with sections of different sizes for the respective regions of a plurality of regions arranged in one direction.

The illumination pattern has a two-dimensional pattern structure formed with a plurality of sections obtained by periodically dividing a rectangular lighting region, for example. The illumination pattern is formed so that light passes through or does not pass through the respective sections of the plurality of sections.

The illuminating system unit 110 is formed with a combination of a light source, a component for giving a pattern to light, and an illumination optical system, for example.

The reception unit 130 receives light from the measurement target irradiated with the illumination pattern output by the illuminating system unit, via a single-pixel photodetector.

The reception unit 130 includes the single-pixel photodetector, for example.

The signal processing unit 150 acquires a reception signal based on the light received by the reception unit, and generates a two-dimensional image of the measurement target for each of the regions on the basis of a change in the acquired reception signal.

In addition to the above configuration, the image acquiring device 100 includes a control unit (not shown), a storage unit (not shown), and a communication unit (not shown).

The control unit (not shown) controls the entire image acquiring device 100 and each component. The control unit (not shown) activates the image acquiring device 100 in accordance with a command from the outside, for example. Also, the control unit (not shown) controls the state (an operating state=a state such as activation, shutdown, or sleep) of the image acquiring device 100.

The storage unit (not shown) stores each piece of the data to be used in the image acquiring device 100. The storage unit (not shown) stores an output (output data) by each component in the image acquiring device 100, and outputs data requested for each component to the requesting source component, for example.

The communication unit (not shown) communicates with an external device. For example, communication is performed between the image acquiring device 100 (100A) and a peripheral device (a display device, for example). In a case where the image acquiring device 100 and the display device are not connected by wire, for example, the communication unit (not shown) has a function of performing communication between the image acquiring device 100 and the display device. Also, the communication unit (not shown) has a function of performing communication with a server device that is an external device.

The control unit (not shown), the storage unit (not shown), and the communication unit (not shown) are the same as above in the embodiments described later.

### Operation

An example operation and an example process to be performed by the image acquiring device according to the first embodiment are now described.

The image acquiring device 100 first outputs the illumination pattern. The image acquiring device 100 irradiates the measurement target with the illumination pattern by outputting light to which a pattern formed with sections of different sizes for the respective regions of a plurality of regions arranged in one direction is given.

The image acquiring device 100 then receives light from the measurement target irradiated with the output illumination pattern, via the single-pixel photodetector.

The image acquiring device 100 then acquires a reception signal based on the received light, and generates a two-dimensional image of the measurement target for each of the regions on the basis of a change in the acquired reception signal.

The image acquiring device 100 outputs the generated two-dimensional image to an image inspecting unit or the like of a measurement system (not shown).

The image inspecting unit of the measurement system (not shown) performs an inspection (an image inspection) on the measurement target using the two-dimensional image, and outputs an inspection result. Specific inspection items are the size, the surface state, and the like of the measurement target.

Note that the image inspecting unit may be included in the image acquiring device 100 as described in an embodiment to be described later.

A specific example of a process to be performed by the image acquiring device 100 is now described.

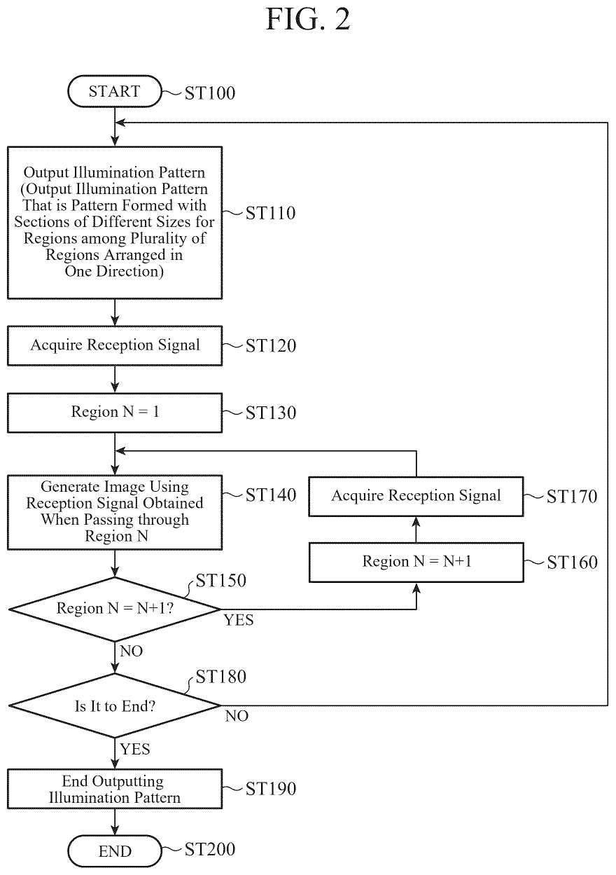

FIG. 2 is a diagram illustrating an example operation to be performed by the image acquiring device 100 according to the first embodiment of the present disclosure.

The process illustrated in FIG. 2 is an image acquiring method implemented by the image acquiring device 100.

For example, the image acquiring device illustrated in FIG. 1 starts the process illustrated in FIG. 2, when instructed to start an operation from outside the device. Alternatively, when presence of the measurement target is detected, the process illustrated in FIG. 2 is started (step ST100).

When starting the processing, the image acquiring device 100 first performs an illumination pattern outputting operation (step ST110).

In the illumination pattern outputting operation, the illuminating system unit 110 of the image acquiring device 100 outputs an illumination pattern that is a pattern formed with sections of different sizes for the respective regions of a plurality of regions arranged in one direction.

When the measurement target passes over the illumination pattern after the illuminating system unit 110 outputs the illumination pattern, the measurement target is irradiated with the illumination pattern.

The image acquiring device 100 then performs a light receiving operation (step ST120).

In the light receiving operation, the reception unit 130 of the image acquiring device 100 receives light from the measurement target irradiated with the illumination pattern output by the illuminating system unit 110, via the single-pixel photodetector.

The reception unit 130 outputs the received light as a reception signal to the signal processing unit 150.

When the image acquiring device 100 determines that the measurement target is present on the illumination pattern, using the reception signal based on the received light, the image acquiring device 100 then performs a process (step ST130) of recognizing that the position of the measurement target (the position during the movement) is a first region (region N=1) in the illumination pattern.

The signal processing unit 150 of the image acquiring device 100 determines that the measurement target has entered the illumination pattern on the basis of a change in the reception signal, for example, and sets the region number to 1 (region N=1).

The image acquiring device 100 then performs an image generating process (step ST140) using the reception signal at the time of passing through the region N.

In the image generating process, the signal processing unit 150 of the image acquiring device 100 acquires the reception signal based on the light received by the reception unit 130, and generates a two-dimensional image of the measurement target for each region (region N) on the basis of a change in the acquired reception signal.

The signal processing unit 150 outputs the generated two-dimensional image to an image inspecting unit or the like of a measurement system (not shown), for example.

After outputting the two-dimensional image generated in the image generating process, the image acquiring device 100 then performs a continuation determining process (region N=N+1?) (step ST150) of determining whether to perform the processing in the next region.

In the continuation determining process, after receiving an inspection result from the image inspecting unit or the like of the measurement system (not shown), the signal processing unit 150 of the image acquiring device 100 determines whether to perform the processing in the next region, depending on the inspection result.

Specifically, when the result of the inspection on the measurement target does not satisfy a preset criterion, for example, the signal processing unit 150 determines not to perform the processing in the next region.

In the continuation determining process (region N=N+1?) (step ST150), if the image acquiring device 100 determines to perform the processing in the next region (step ST150 “YES”), the image acquiring device 100 then performs a region setting process (step ST160) of performing setting for the processing in the next region (region N=N+1).

In the region setting process, the signal processing unit 150 of the image acquiring device 100 sets the region next to the region that is the previous processing target, as the processing target region.

Specifically, the region number is set to the number (region N=N+1) obtained by adding 1 to the region number indicating the region that is the previous processing target, for example.

The signal processing unit 150 acquires the reception signal in a state where the measurement target is passing through the region N (step ST170).

The signal processing unit 150 then proceeds to the processing in step ST140, and performs the image generating process related to the measurement target passing through the next region.

If the image acquiring device 100 determines not to perform the processing in the next region (step ST150 “NO”), the image acquiring device 100 then proceeds to an end determining process (step ST180).

In the end determining process, the control unit (not shown) of the image acquiring device 100 determines whether to end the process being performed by the image acquiring device 100. The control unit (not shown) determines whether to end the process being performed by the image acquiring device 100, in accordance with an end command from outside or an execution program, for example.

If the control unit (not shown) determines not to end the process being performed by the image acquiring device 100 (step ST180 “NO”), the image acquiring device 100 proceeds to the processing in step ST110, and repeats the process starting from the processing in step ST110.

If the control unit (not shown) determines to end the process being performed by the image acquiring device 100 (step ST180 “YES”), the image acquiring device 100 performs an illumination pattern output ending process (step ST190).

In the illumination pattern output ending process, the signal processing unit 150 of the image acquiring device 100 instructs the illuminating system unit 110 to end the irradiation of the illumination pattern. The image acquiring device 100 then ends the process (step ST200).

### Effects According to First Embodiment

An image acquiring device of the present disclosure is designed as follows, for example.

An image acquiring device including:
an illuminating system unit that outputs an illumination pattern that is a pattern formed with sections of different sizes for the respective regions of a plurality of regions arranged in one direction;
a reception unit that receives light from a measurement target irradiated with the illumination pattern output by the illuminating system unit, via a single-pixel photodetector; and
a signal processing unit that acquires a reception signal based on the light received by the reception unit, and generates a two-dimensional image of the measurement target for each of the regions on the basis of a change in the acquired reception signal.

Thus, the present disclosure has an effect of providing an image acquiring device that can shorten a measurement time required for one measurement target in a case where the measurement target is measured with a two-dimensional image by an SPI technology for obtaining the two-dimensional image of a measurement target using a single illumination pattern.

An image acquiring method of the present disclosure is designed as follows, for example.

An image acquiring method implemented by an image acquiring device, in which
the image acquiring device outputs an illumination pattern that is a pattern formed with sections of different sizes for the respective regions of a plurality of regions arranged in one direction,
the image acquiring device receives light from a measurement target irradiated with the output illumination pattern, via a single-pixel photodetector, and
the image acquiring device acquires a reception signal based on the received light, and generates a two-dimensional image of the measurement target for each of the regions on the basis of a change in the acquired reception signal.

Thus, the present disclosure has an effect of providing an image acquiring method by which the measurement time required for one measurement target can be shortened in a case where a measurement target is measured with a two-dimensional image by the SPI technology for obtaining the two-dimensional image of the measurement target using a single illumination pattern.

### Second Embodiment

A second embodiment concerns a more specific mode of the first embodiment.

In the second embodiment, among the components according to the second embodiment, the components that are the same as or similar to components according to the already-described first embodiment are given the same names and are denoted by the same or similar reference signs, and redundant explanation of them is omitted as appropriate.

### Configuration

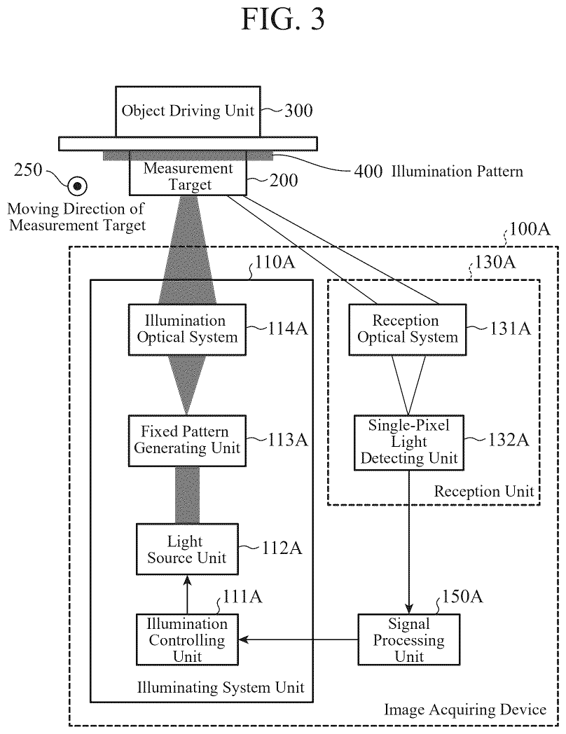

FIG. 3 is a diagram illustrating an example configuration of an image acquiring device 100A according to the second embodiment of the present disclosure, and an example configuration in a case where the image acquiring device 100A is adopted in a measurement system.

The image acquiring device 100A illustrated in FIG. 3 includes an illuminating system unit 110A, a reception unit 130A, and a signal processing unit 150A.

An illumination controlling unit 111A has a function of receiving a control signal from the signal processing unit 150A, and a function of controlling switching on and off of output light from a light source unit 112A on the basis of the control signal.

The light source unit 112A has a function of irradiating a fixed pattern generating unit 113A with light, on the basis of the control of the illumination controlling unit 111A.

The fixed pattern generating unit 113A has a function of giving a spatial modulation pattern to the light emitted from the light source unit 112A. Specifically, the fixed pattern generating unit 113A gives a two-dimensional pattern to the light emitted from the light source unit 112A, the two-dimensional pattern being formed with sections of different sizes for the respective regions of a plurality of regions arranged in one direction. The fixed pattern generating unit 113A forms the pattern generating unit of the present disclosure.

The spatial pattern to be generated by the fixed pattern generating unit 113A is always the same, and does not have a function of dynamically changing the pattern, unlike a spatial light modulator represented by a DMD. Thus, the fixed pattern generating unit 113A, and the optical system and the control system in the vicinity are reduced in size and cost, and are improved in reliability.

An illumination optical system 114A has a function of transferring the spatial modulation pattern given to the light having passed through the fixed pattern generating unit 113A, onto a measurement target 200. The modulation pattern to be transferred is an illumination pattern 400.

That is, the illumination optical system 114A projects the illumination pattern, which is light having a two-dimensional pattern given thereto by the pattern generating unit (the fixed pattern generating unit 113A), onto the measurement target.

The illumination optical system 114A is an image-forming optical system including lenses and mirrors, and the shapes and the numbers of the lenses and the mirrors are not limited to any particular shapes and numbers.

The illumination pattern 400 is a two-dimensional spatial illumination pattern to be transferred onto the measurement target 200 by the illumination optical system 114A.

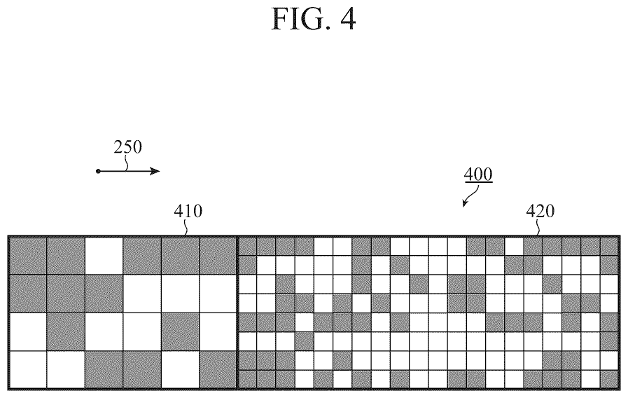

FIG. 4 is a diagram illustrating a first example of the illumination pattern irradiated by the illuminating system unit 110A in the image acquiring device 100A according to the second embodiment of the present disclosure.

FIG. 4 is an example of the illumination pattern 400. The illumination pattern 400 has a structure two-dimensionally divided into a large number of sections, and the size of the sections is large in a low-resolution region (first region) 410 and is small in a high-resolution region (second region) 420. Here, the section size in the low-resolution region (first region) 410 is 2×2=four times larger than that in the high-resolution region (second region) 420. The low-resolution region (first region) 410 and the high-resolution region (second region) 420 are arranged in such order that the measurement target 200 first enters the low-resolution region (first region) 410, because a low-resolution image is to be first acquired. Note that, in FIG. 4, two regions are shown as the plurality of regions in the illumination pattern 400, but three or more regions may be formed therein. Note that the luminance of each section may have a physical meaning like a wavelet or Fourier, or may be random. Also, there may be a luminance distribution among the sections.

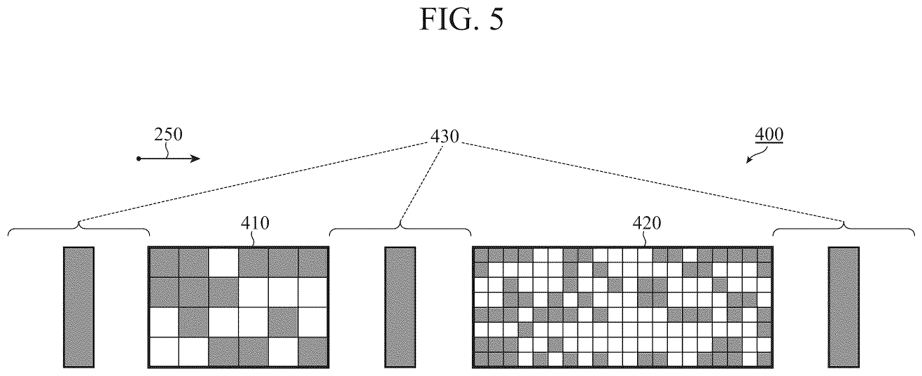

FIG. 5 is a diagram illustrating a second example of the illumination pattern irradiated by the illuminating system unit 110A in the image acquiring device 100A according to the second embodiment of the present disclosure.

FIG. 5 is another example of the illumination pattern 400, and includes a temporally-synchronized pattern (second region) 430, in addition to the low-resolution region (first region) 410 and the high-resolution region (second region) 420. The temporally-synchronized pattern (second region) 430 is used to associate a reception signal with a position of the measurement target as described later.

The measurement target 200 is a target whose image is to be acquired by the image acquiring device according to the present disclosure. The size of the measurement target 200 is smaller than the region of the illumination pattern corresponding to an image output from the device. For example, when an image with a resolution of 32×32 is output, the measurement target 200 is smaller than the range of 32×32 sections in the illumination pattern.

An object driving unit 300 has a function of moving the measurement target 200 at a constant speed. A moving direction 250 is perpendicular to the paper surface in FIG. 3. The object driving unit 300 is a belt conveyor that is used on a factory line, for example.

A reception optical system 131A has a function of condensing the illumination pattern 400 reflected and/or scattered by the measurement target 200 onto a single-pixel light detecting unit 132A. “Reflection and/or scattering” means reflection, scattering, or reflection and scattering. The reception optical system 131A is an image-forming optical system including lenses and mirrors, and the shapes and the numbers of the lenses and the mirrors are not limited to any particular shapes and numbers.

The single-pixel light detecting unit 132A has a function of converting light collected by the reception optical system 131A into an electric signal. The single-pixel light detecting unit 132A receives light corresponding to a relative position between the measurement target and the illumination pattern, and outputs the reception signal on the basis of the received light. The single-pixel light detecting unit 132A acquires a signal in a period equal to or shorter than the time in which the measurement target 200 passes through one section in the illumination pattern 400. The single-pixel light detecting unit 132A is a so-called photodetector, and one formed with Si in a visible wavelength band and one formed with InGaAs or Ge in a short infrared wavelength band are generally used.

The signal processing unit 150A has a function of receiving the electric signal from the single-pixel light detecting unit 132A, and reconstructing an image of the measurement target 200. The signal processing unit 150A generates a two-dimensional image having a different resolution for each region, using the reception signal acquired for each region when the measurement target 200 passes through the region in the illumination pattern 400.

In the present embodiment, among the respective regions in the illumination pattern, the regions having different section sizes are arranged in such a manner as to be arranged from the region having the larger section size toward the region having the smaller section size in the direction in which the measurement target moves.

In this case, the signal processing unit 150A generates a low-resolution two-dimensional image from a signal acquired in a region where the sections are large, and generates a high-resolution two-dimensional image from a signal acquired in a region where the sections are small.

Alternatively, the signal processing unit 150A may be designed in such a manner as to generate a low-resolution two-dimensional image from a signal acquired in a region with the larger section size, generate a high-resolution two-dimensional image from both signals acquired in a region with the smaller section size and a region with the larger section size, and, when a high-resolution two-dimensional image is generated, match the resolution of the illumination frame corresponding to a signal acquired in a region with the larger section size with the resolution of the illumination frame corresponding to a signal acquired in a region with the smaller section size.

A specific example of the configuration of the illuminating system unit 110A is now described.

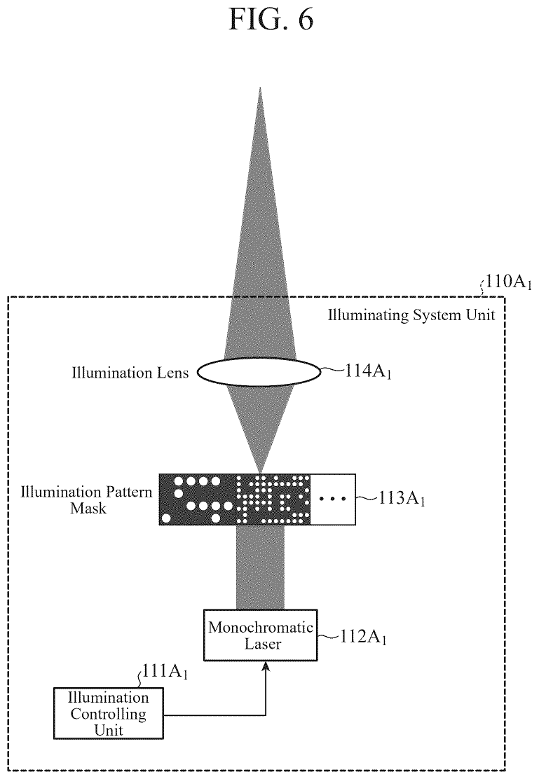

FIG. 6 is a diagram illustrating an example configuration of the illuminating system unit 110A in the image acquiring device 100A according to the second embodiment of the present disclosure.

In FIG. 6, the illuminating system unit 110A₁ includes a monochromatic laser (light source unit) 112A₁, an illumination pattern mask (pattern generating unit) 113A₁, and an illumination lens 114A₁.

The monochromatic laser (light source unit) 112A₁ is a laser light source, and has a function of controlling an output depending on a signal from an illumination controlling unit 111A₁.

The illumination pattern mask (pattern generating unit) 113A₁ has a function of giving a spatial modulation pattern to light from the monochromatic laser (light source unit) 112A₁. The illumination pattern mask (pattern generating unit) 113A₁ is formed with a large number of sections arranged two-dimensionally, and has small holes formed at the centers of some sections, for example. With this arrangement, a binary pattern in which the sections having the small holes are represented by 1, and the sections without the small holes are represented by 0 is provided. Because such an illumination pattern mask (pattern generating unit) 113A₁ can be mass-produced by laser processing, the manufacturing costs are low in a preferred manner. In a region corresponding to the low-resolution region (first region) 410, one large hole is formed in the larger sections than those in the high-resolution region (second region) 420.

The illumination lens 114A₁ has a function of transferring the illumination pattern mask (pattern generating unit) 113A₁ onto the measurement target 200.

A specific example of the configuration of the signal processing unit 150A is now described.

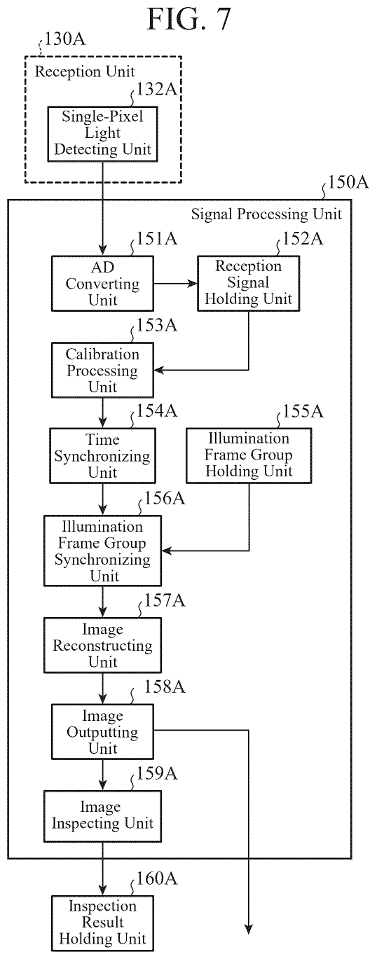

FIG. 7 is a diagram illustrating an example configuration of the signal processing unit 150A in the image acquiring device 100A according to the second embodiment of the present disclosure.

The signal processing unit 150A illustrated in FIG. 7 includes an AD converting unit 151A, a reception signal holding unit 152A, a time synchronizing unit 154A, a calibration processing unit 153A, an illumination frame group holding unit 155A, an illumination frame group synchronizing unit 156A, an image reconstructing unit 157A, an image outputting unit 158A, and an image inspecting unit 159A.

The AD converting unit 151A has a function of converting the electric signal from the single-pixel light detecting unit 132A into a digital signal.

The reception signal holding unit 152A has a function of holding the signal (reception signal) from the AD converting unit 151A.

The calibration processing unit 153A has a function of extracting a reception signal from the reception signal holding unit 152A, and a function of calibrating the extracted reception signal. Specifically, dark-time calibration, sensitivity calibration, and the like are performed.

The time synchronizing unit 154A has a function of associating signals from the calibration processing unit 153A with positions (illumination pixel numbers in the illumination pattern) of the measurement target 200. When the moving speed of the measurement target 200 is known, synchronizing can be performed by detecting the time at which the measurement target 200 entered the illumination pattern 400 on the basis of a rise or the like of the reception signal. When the moving speed of the measurement target 200 is unknown, it is also possible to associate the time axis of the reception signal with the positions of the measurement target 200, by assigning a characteristic pattern to the left end and the right end of the illumination pattern 400 in the horizontal direction as illustrated in FIG. 5, and identifying the characteristic shape of the reception signal at the timing of passing over the characteristic pattern.

The illumination frame group holding unit 155A has a function of holding an illumination frame group corresponding to the illumination pattern 400. An illumination frame is an apparent illumination pattern with which the measurement target 200 is irradiated, and corresponds to the one obtained by cutting out the range corresponding to the measurement target 200 from the illumination pattern. An illumination frame group is obtained by virtually moving the measurement target 200 section by section, extracting the illumination frames at the respective positions of the measurement target 200, and putting the illumination frames together. When the number of sections in the illumination pattern 400 is 32×301, and the size of the measurement target 200 corresponds to 32×32 sections, the illumination frame group has 270 illumination frames with a resolution of 32×32, and accordingly, the illumination frame group has an array of 32×32×270.

The illumination frame group synchronizing unit 156A has a function of associating the respective points of the reception signal corresponding to the illumination pattern 400 with the respective illumination frames in the illumination frame group output from the illumination frame group holding unit 155A.

The image reconstructing unit 157A has a function of performing an image reconstructing process on the reception signal and the illumination frame group output from the illumination frame group synchronizing unit 156A, and generating a two-dimensional image of the measurement target 200.

The image outputting unit 158A has a function of transmitting the two-dimensional image generated by the image reconstructing unit 157A to the outside of the device or to the image inspecting unit 159A.

The image inspecting unit 159A has a function of performing image inspection on the acquired image. Specific inspection items in the image inspection include the size and the surface state of the measurement target 200, for example.

Also, the image inspecting unit 159A performs image inspections of different inspection items on two-dimensional images having different resolutions.

Further, the image inspecting unit 159A performs an inspection of at least one of the inspection items of the image inspections while the measurement target is moving over the illumination pattern. Since image inspections are normally performed with respect to a plurality of inspection items, a result of at least one inspection item among the plurality of inspection items is obtained while the measurement target is moving over the illumination pattern, and thus, the inspection time can be shortened. For example, when a failed inspection result is obtained with respect to one inspection item using a low-resolution image at the beginning of image inspection, it is possible not to execute the subsequent inspection of the inspection items, and the inspection time can be shortened. Also, the processing load on the signal processing unit 150A is reduced.

An inspection result holding unit 160A has a function of holding the result of the inspection performed by the image inspecting unit 159A.

### Operation

An example operation and an example process to be performed by the image acquiring device according to the second embodiment of the present disclosure are now described.

First, an example process to be performed by the signal processing unit 150A in the image acquiring device 100A is described.

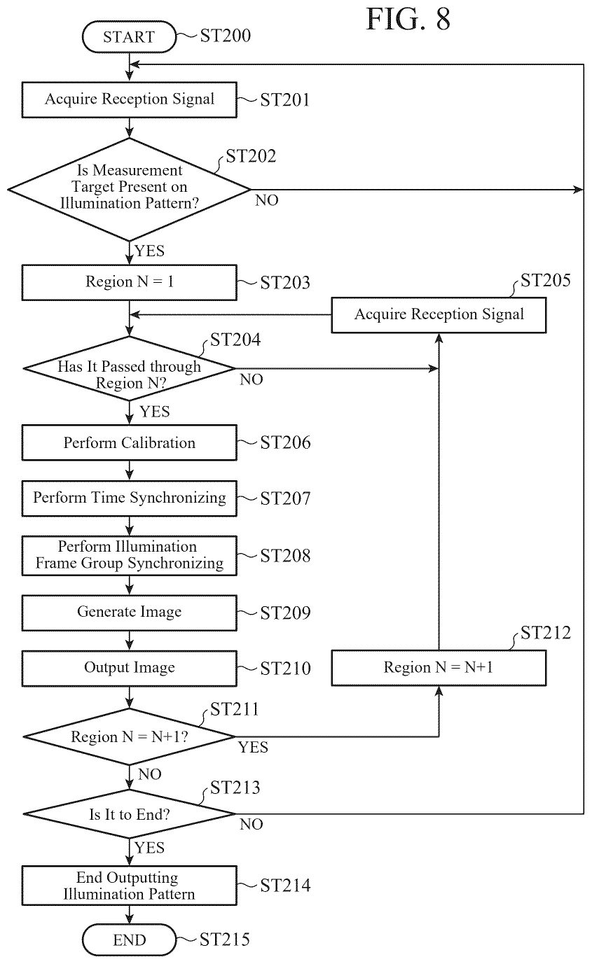

FIG. 8 is a flowchart illustrating an example process to be performed by the signal processing unit 150A in the image acquiring device 100A according to the second embodiment of the present disclosure.

For example, when the image acquiring device 100A is activated, the signal processing unit 150A starts the process illustrated in FIG. 8 (step ST200).

After starting the process, the signal processing unit 150A first acquires a reception signal (step ST201).

In step ST201, when acquiring a reception signal based on light received by the single-pixel light detecting unit 132A of the reception unit 130A, the AD converting unit 151A of the signal processing unit 150A converts the reception signal into a digital signal, and outputs the converted reception signal to the reception signal holding unit 152A.

The reception signal holding unit 152A holds and stores the reception signal (reception signal data).

The signal processing unit 150A then determines whether the measurement target is present on the illumination pattern (step ST202).

The signal processing unit 150A determines whether the measurement target is present on the illumination pattern, using the reception signal held in the reception signal holding unit 152A.

When the signal processing unit 150A determines that the measurement target is present on the illumination pattern (step ST202 “YES”), the signal processing unit 150A then performs a process (step ST203) of recognizing that the position of the measurement target (the position during the movement) is a first region (region N=1) in the illumination pattern.

The signal processing unit 150A determines that the measurement target has entered the illumination pattern on the basis of a change in the reception signal, for example, and sets the region number to 1 (region N=1). In this case, a region number is an identification number determined beforehand for each region in the illumination pattern, and region numbers N=1, 2, . . . are assigned in the order of the regions through which the moving measurement target passes.

The signal processing unit 150A determines whether the measurement target has passed through the region N (step ST204).

In step ST204, when the moving speed of the measurement target 200 is known, the signal processing unit 150A performs determination from the time elapsed since the measurement target 200 entered the illumination pattern 400. When the moving speed is unknown, on the other hand, the signal processing unit 150A gives a characteristic pattern after the high-resolution region (second region) 420, and performs determination from the presence or absence of a reception signal at the time when the measurement target passes over the pattern.

When determining that the measurement target has not passed through the region N (step ST204 “NO”), the signal processing unit 150A continues to acquire and store a reception signal (step ST205).

In step ST205, the AD converting unit 151A and the reception signal holding unit 152A of the signal processing unit 150A operate in the same manner as in step ST201, and hold and store the reception signal (reception signal data). The signal processing unit 150A then proceeds to step ST204, and determines whether the measurement target has passed through the region N.

If it is determined that the measurement target has passed through the region N (step ST204 “YES”), the signal processing unit 150A then performs a calibration process (step ST206).

In the calibration process, the calibration processing unit 153A of the signal processing unit 150A extracts the reception signal from the reception signal holding unit 152A, and performs a calibration process such as dark-time calibration, sensitivity calibration, or dark-time calibration and sensitivity calibration on the extracted reception signal.

The signal processing unit 150A then performs a time synchronizing process (step ST207).

In the time synchronizing process, the time synchronizing unit 154A of the signal processing unit 150A associates the signal from the calibration processing unit 153A with the position (an illumination pixel number in the illumination pattern) of the measurement target 200.

The signal processing unit 150A then performs an illumination frame group synchronizing process (step ST208).

In the illumination frame group synchronizing process, the illumination frame group synchronizing unit 156A of the signal processing unit 150A associates the respective points of the reception signal corresponding to the illumination pattern 400 with the respective illumination frames in the illumination frame group output from the illumination frame group holding unit 155A.

The illumination frame group synchronizing unit 156A outputs the reception signal and the illumination frame group associated with each other to the image reconstructing unit 157A.

The signal processing unit 150A then performs an image generating process (step ST209).

In the image generating process, the image reconstructing unit 157A of the signal processing unit 150A performs an image reconstructing process on the reception signal and the illumination frame group output from the illumination frame group synchronizing unit 156A, and generates a two-dimensional image of the measurement target 200.

The image reconstructing unit 157A outputs the generated two-dimensional image to the image outputting unit 158A.

The signal processing unit 150A performs an image outputting process (step ST210).

In the image outputting process, after receiving the two-dimensional image generated by the image reconstructing unit 157A, the image outputting unit 158A of the signal processing unit 150A transmits the two-dimensional image to the outside of the image acquiring device or to the image inspecting unit 159A.

After outputting the two-dimensional image generated in the image generating process, the signal processing unit 150A then performs a continuation determining process (region N=N+1?) (step ST211) of determining whether to perform the processing in the next region.

In the continuation determining process, after receiving an inspection result from the image inspecting unit or the like of the measurement system (not shown), the signal processing unit 150A determines whether to perform the processing in the next region, depending on the inspection result.

Specifically, when the result of the inspection on the measurement target does not satisfy a preset criterion, for example, the signal processing unit 150A determines not to perform the processing in the next region.

In the continuation determining process (region N=N+1?) (step ST211), if the signal processing unit 150A determines to perform the processing in the next region (step ST211 “YES”), the signal processing unit 150A then performs a region setting process (step ST212) of performing setting for the processing in the next region (region N=N+1).

In the region setting process, the signal processing unit 150A sets the region next to the region that is the previous processing target, as the processing target region.

Specifically, the region number is set to the number (region N=N+1) obtained by adding 1 to the region number indicating the region that is the previous processing target, for example.

The signal processing unit 150A acquires the reception signal in a state where the measurement target is passing through the region N (step ST205).

The signal processing unit 150A then proceeds to the processing in step ST204, and performs the image generating process related to the measurement target passing through the next region.

If the signal processing unit 150A determines not to perform the processing in the next region (step ST211 “NO”), the signal processing unit 150A then proceeds to an end determining process (step ST213).

In the end determining process, the signal processing unit 150A determines whether the image acquiring device 100A is to end the process. After determining to end the process being performed by the image acquiring device 100A in accordance with an end command from outside or an execution program, for example, the control unit (not shown) of the image acquiring device 100A instructs the signal processing unit 150A to end the process.

If the control unit (not shown) determines not to end the process being performed by the image acquiring device 100A (step ST213 “NO”), the signal processing unit 150A proceeds to the processing in step ST201, and repeats the process starting from the processing in step ST201.

If the control unit (not shown) determines to end the process being performed by the image acquiring device 100A (step ST213 “YES”), the signal processing unit 150A performs an illumination pattern output ending process (step ST214).

In the illumination pattern output ending process, the signal processing unit 150A instructs the illuminating system unit 110A to end the irradiation of the illumination pattern. The signal processing unit 150A then ends the process (step ST215).

Next, an example operation to be performed by the image acquiring device 100A is described.

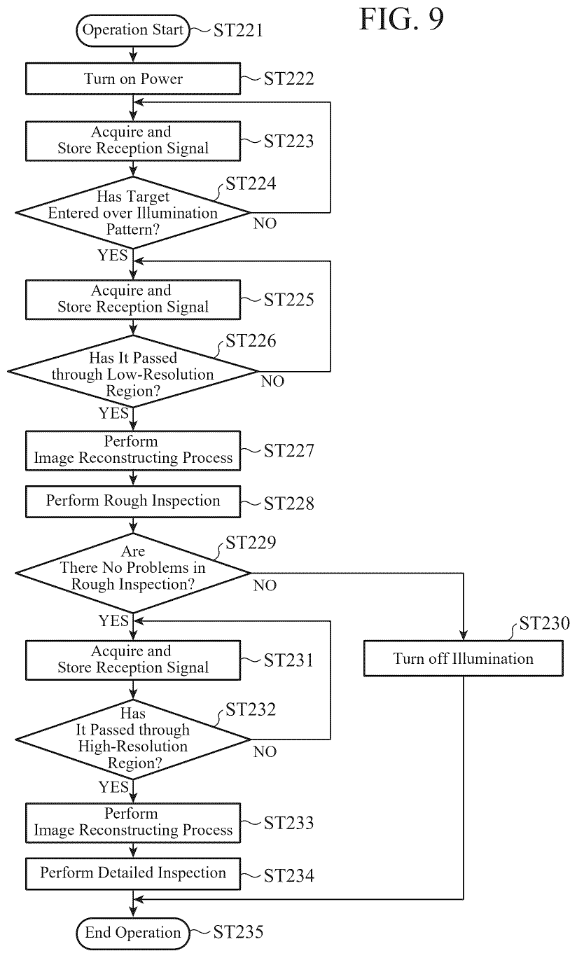

FIG. 9 is a flowchart illustrating an example operation to be performed in the image acquiring device 100A according to the second embodiment of the present disclosure.

The image acquiring device 100A first starts an operation in step ST221.

The image acquiring device 100A then proceeds to step ST222. In step ST222, the power to the light source unit 112A is turned on, and irradiation of the illumination pattern 400 is started. In step ST222, the illumination controlling unit 111A in the illuminating system unit 110A of the image acquiring device 100A controls the light source unit 112A in response to a command from the signal processing unit 150A.

The image acquiring device 100A then proceeds to step ST223. In step ST223, the power to the AD converting unit 151A and the single-pixel light detecting unit 132A is turned on, and acquisition and recording of the reception signal is started.

The image acquiring device 100A then proceeds to step ST224. In step ST224, a check is made at regular time intervals to determine whether the measurement target 200 has entered the illumination pattern 400. If the measurement target 200 has not entered, the process returns to step ST223, and, if it has, the process proceeds to the next step. Entering may be detected from a rise of the reception signal, or may be detected from the reception signal at the time when a characteristic pattern given to the side of the illumination pattern 400 from which the measurement target 200 enters has passed over the pattern.

Step ST224 is carried out by the signal processing unit 150A of the image acquiring device 100A, for example.

The image acquiring device 100A then proceeds to step ST225. In step ST225, the reception signal after the measurement target 200 has entered the illumination pattern 400 is continuously acquired and recorded. The “acquiring and recording” means acquiring and recording.

Step ST225 is carried out by the AD converting unit 151A and the reception signal holding unit 152A cooperating with each other in the signal processing unit 150A of the image acquiring device 100A.

The image acquiring device 100A then proceeds to step ST226. In step S226, a check is made at regular time intervals to determine whether the measurement target 200 has passed over the low-resolution region (first region) 410 in the illumination pattern 400. If the measurement target 200 has not passed, the process returns to step ST225, and, if it has, the process proceeds to the next step. When the moving speed of the measurement target 200 is known, it is possible to determine whether or not it has passed, from the time elapsed since the measurement target 200 entered the illumination pattern 400. When the moving speed is unknown, on the other hand, a characteristic pattern is provided between the low-resolution region (first region) 410 and the high-resolution region (second region) 420, and determination may be performed from the presence or absence of the reception signal at the time when the measurement target passes over the pattern.

The image acquiring device 100A then proceeds to step ST227. In step ST227, an image reconstructing process is performed by the signal processing unit 150A using the reception signal corresponding to the low-resolution region (first region) 410. As a result, a low-resolution image having the resolution corresponding to the low-resolution region (first region) 410 is output.

The image acquiring device 100A then proceeds to step ST228. In step ST228, the image inspecting unit 159A is used to perform a rough inspection on the low-resolution image. The rough inspection is an inspection of items that can be inspected from a low-resolution image, and includes a size inspection and a large flaw and/or defect inspection on the measurement target 200, for example. After that, the inspection result is stored into the inspection result holding unit 160A. As the rough inspection is performed as described above in step ST228, part of the image inspection can be completed before the measurement target 200 passes over the entire illumination pattern 400, and the time required for the image acquisition and the entire image inspection can be shortened.

The image acquiring device 100A then proceeds to step ST229. In step ST229, a check is made to determine whether there is a problem in the rough inspection. If there are no problems (step ST229 “YES”), or if there are no items not satisfying criteria among the items of the rough inspection, the process proceeds to the next step (step ST231). If there is a problem (step ST229 “NO”), or if there is an item not satisfying a criterion among the items of the rough inspection, the subsequent inspections are no longer necessary. Therefore, the power to the light source unit 112A is turned off (illumination OFF: step ST230), and the process skips to step ST235 and ends the operation. Thus, it is possible to reduce power consumption due to the illumination while the measurement target 200 moves over the high-resolution region (second region) 420. Also, since it is possible to determine at an early stage that a criterion is not satisfied, the interval before the next measurement target is input can be shortened.

The image acquiring device 100A then proceeds to step ST231. In step S231, the reception signal after the measurement target 200 has entered the high-resolution region (second region) 420 in the illumination pattern 400 is continuously acquired and recorded. Note that step ST231 is also continuously carried out between step ST226 and step ST229.

The image acquiring device 100A then proceeds to step ST232. In step S232, a check is made at regular time intervals to determine whether the measurement target 200 has passed over the high-resolution region (second region) 420 in the illumination pattern 400. If the measurement target 200 has not passed, the process returns to step S231, and, if it has, the process proceeds to the next step. When the moving speed of the measurement target 200 is known, it is possible to determine whether or not it has passed, from the time elapsed since the measurement target 200 entered the illumination pattern 400. When the moving speed is unknown, on the other hand, a characteristic pattern is provided after the high-resolution region (second region) 420, and determination may be performed from the presence or absence of the reception signal at the time when the measurement target passes over the pattern.

The image acquiring device 100A then proceeds to step ST234. In step S234, a detailed inspection using the image inspecting unit 159A is performed on the high-resolution image. The detailed inspection is an inspection of items that are difficult to inspect from a low-resolution image, and includes a small flaw and/or defect inspection on the measurement target 200, for example. The “flaw and/or defect” means a flaw, a defect, or a flaw and a defect. After that, the inspection result is stored into the inspection result holding unit 160A. Since the rough inspection has been completed in step S228, the time required for the detailed inspection is shortened.

The image acquiring device 100A then finally completes the operation in step S235.

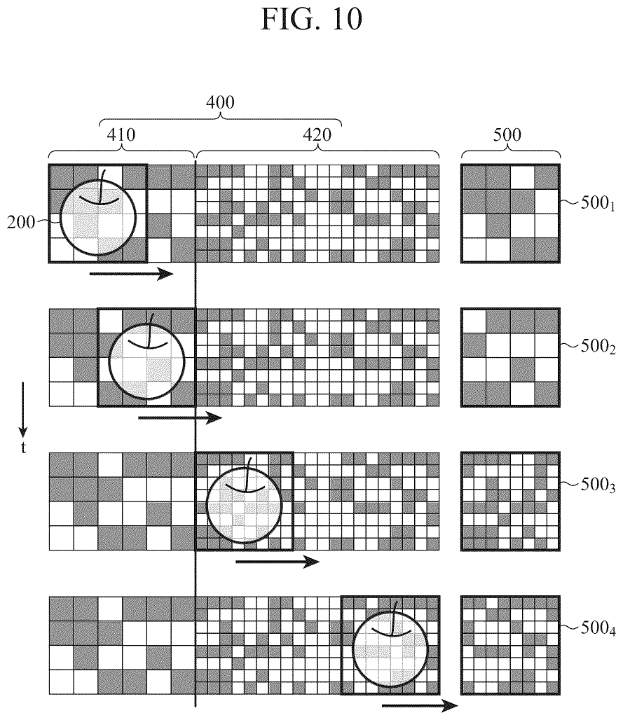

FIG. 10 is a diagram for explaining an operation related to acquisition of a reception signal in the image acquiring device 100A according to the second embodiment of the present disclosure.

The measurement target 200 moves in the horizontal direction on the illumination pattern 400. The apparent illumination pattern (=illumination frame) 500 (500₁, 500₂, 500₃, 500₄) with which the measurement target 200 is irradiated changes with the movement of the measurement target 200. Although the illumination pattern is a single pattern, the illumination frame 500 (500₁, 500₂, 500₃, 500₄) changes. Accordingly, a process equivalent to that in general SPI can be performed.

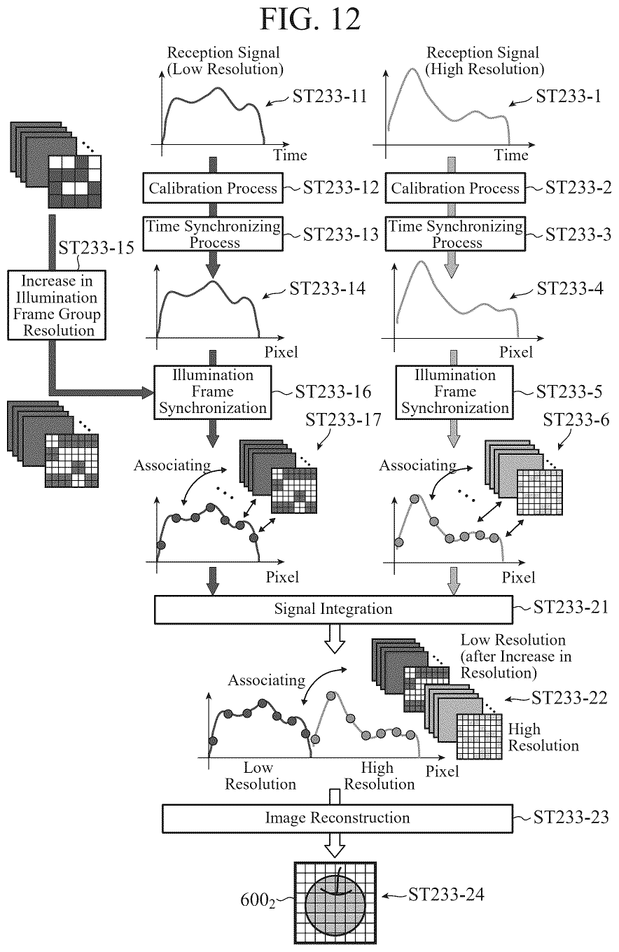

Since the illumination frames corresponding to the low-resolution region (first region) 410 have a low resolution, the image acquired when an image is reconstructed with only the reception signal corresponding to the low-resolution region (first region) 410 has a low resolution. Since the illumination frames corresponding to the high-resolution region (second region) 420 have a high resolution, on the other hand, the image acquired when an image is reconstructed with only the reception signal corresponding to the high-resolution region (second region) 420 has a high resolution. Note that, in the latter case, the image reconstruction can be performed with the reception signal corresponding to the low-resolution region (first region) 410, in addition to the reception signal corresponding to the high-resolution region (second region) 420. In that case, the number of available data points increases, and thus, increase in image reconstruction accuracy can be expected. Note that, when the reception signal corresponding to the low-resolution region (first region) 410 is used, the corresponding illumination frames are subjected to oversampling (two-dimensional interpolation) to have the same resolution as that of the illumination frames corresponding to the high-resolution region (second region) 420. (See FIG. 12 to be described later)

Scattered light and/or reflected light at each position of the measurement target 200 is converted into a continuous electric signal by the reception optical system 131A and the single-pixel light detecting unit 132A, and is transmitted to the signal processing unit 150A.

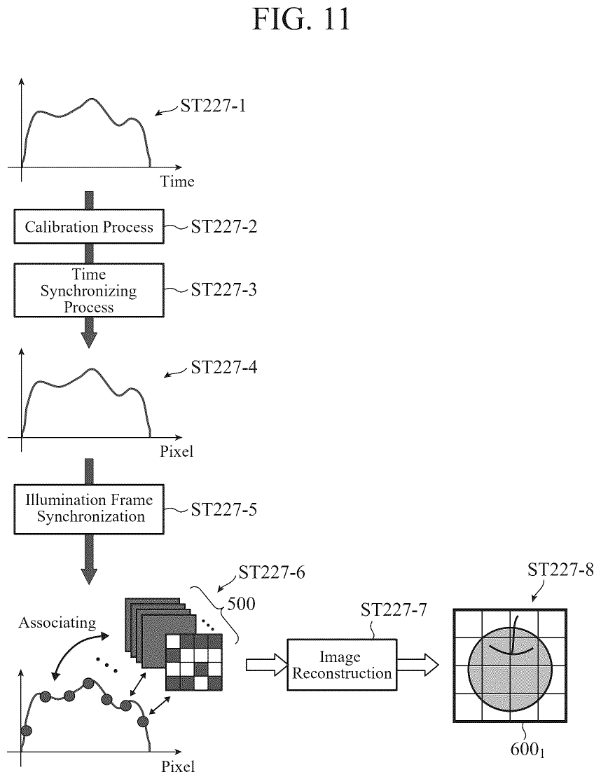

FIG. 11 is a diagram for explaining a first image reconstructing process related to the signal processing unit 150A in the image acquiring device 100A according to the second embodiment of the present disclosure.

Specifically, FIG. 11 is an explanatory diagram related to an image reconstructing process for the reception signal corresponding to the low-resolution region (first region) 410 in the second embodiment.

First, a reception signal (a reception signal is acquired in step ST227-1) is subjected to dark-time correction or sensitivity correction in a calibration process (step ST227-2).

Next, in a time synchronizing process (step ST227-3, step ST227-4), the time axis of the reception signal is associated with the position (=the section number of the low-resolution region (first region) 410 in the illumination pattern 400) of the measurement target 200. Although the correspondence between the time axis of the signal and the position of the measurement target 200 is unknown before the time synchronizing process, a characteristic pattern is given to the left end and the right end of the low-resolution region (first region) 410 of the illumination pattern 400 in the horizontal direction, for example, and the timing at which the measurement target 200 has passed over the characteristic pattern is identified in the reception signal, so that the time axis and the position of the measurement target 200 can be associated with each other. Alternatively, when the moving speed of the measurement target 200 is known, time synchronization using the timing of a rise of the reception signal is also possible.

The reception signal after the time synchronizing process is associated with the illumination frame group corresponding to the respective points in an illumination frame synchronizing process (step ST227-5, step ST227-6). The reception signal is normally a continuous signal, but only the data points (=hereinafter simply referred to as the data points) corresponding to the respective illumination frames included in the illumination frame group are retrieved by synchronization with the illumination frame group, and the reception signal turns into a discrete signal. At this point of time, for example, noise can be reduced by averaging the points around the corresponding data points.

Finally, an image reconstructing process (step ST227-7, step ST227-8) is performed with the illumination frame group and the corresponding data points, and an image (two-dimensional image) 600₁ is generated. The process of image acquisition by SPI can be expressed as follows.

$$y = Ax \qquad ( 1 )$$

In Formula (1), “y” represents a measurement value vector (N×1, the data points corresponding to the illumination frame group), “x” represents a measurement target vector (M²×1, vectorized with rearranged elements of the measurement target 200 (resolution=M×M)), and “A” represents a measurement matrix (N×M²). Note that “N” represents the number of the illumination frames included in the illumination frame group, and “M” represents the resolution of one side of the measurement target 200. When the illumination frames are represented by I₁, I₂, . . . , and I_{N}, the measurement matrix A can be expressed as shown in the following Formula (2).

$$A = {[ vec [ {I}_{1} ] vec [ {I}_{2} ] … vec [ {I}_{N} ] ]}^{t} \qquad ( 2 )$$

Here, in Formula (2), “vec [ ]” represents an operator that rearranges the elements of a matrix and vectorizes the matrix, and “[ ]” represents transposition.

In SPI, it is necessary to solve an inverse problem of estimating “x” to be measured, using known “y” and “A”.

As methods for solving the above, there are known methods such as a method similar to ghost imaging for obtaining a correlation between data points and a frame group, and a method similar to compression sensing in which the above formula is used as an optimization problem. The compression sensing method is characteristically capable of reproducing an image of a measurement target even under a condition where data points are limited as shown in N<M², and is particularly effective in a configuration like the present embodiment in which the number of data points (=the number of illumination frames) is limited by the illumination pattern size.

FIG. 12 is a diagram for explaining a second image reconstructing process related to the signal processing unit 150A in the image acquiring device 100A according to the second embodiment of the present disclosure.

Specifically, FIG. 12 is an explanatory diagram related to an image reconstructing process for the reception signal corresponding to the high-resolution region (second region) 420 in the second embodiment. FIG. 12 illustrates that the process is to be performed from step ST233-1 to ST233-24.

A process substantially equivalent to that in FIG. 11 is performed on the reception signal corresponding to the high-resolution region (second region) 420 (from step ST233-1 to step ST233-6, step ST233-23, step ST233-24). The difference lies in that the reception signal corresponding to the low-resolution region (first region) 410 is also used, and both reception signals are integrated, so that the number of data points is increased and the image reconstruction accuracy is improved (in particular, step ST233-11 to step ST233-17, step ST233-21, step ST233-22).

Therefore, the illumination frame group corresponding to the low-resolution region (first region) 410 is subjected to oversampling using an illumination-frame-group resolution increasing process, and the resolution is matched with that of the illumination frames corresponding to the high-resolution region (second region) 420 (in particular, step ST233-15). Specifically, the signal processing unit 150A performs oversampling (two-dimensional interpolation) on the corresponding illumination frames between the illumination frames of the low-resolution region (first region) 410 and the illumination frames of the high-resolution region (second region) 420, and causes the corresponding illumination frames to have the same resolution as that of the illumination frames corresponding to the high-resolution region (second region) 420.

### Effects According to Second Embodiment

By forming a configuration as in the present embodiment, part of the image inspection can be completed before the measurement target passes over the illumination pattern, and the time required for the image acquisition and the entire image inspection can be shortened.

Furthermore, since it is possible to determine whether the measurement target does not satisfy the criteria for the inspection items before the measurement target passes over the illumination pattern, the power for illumination can be reduced by turning off the power source, and image acquisition and inspection efficiency can be enhanced by shortening the intervals at which measurement targets are input.

An image acquiring device of the present disclosure according to the present embodiment is designed as follows, for example.

An image acquiring device in which
the illuminating system unit includes:
a light source unit;
a pattern generating unit that gives a two-dimensional pattern to light emitted from the light source unit, the two-dimensional pattern being formed with sections of different sizes for the respective regions of a plurality of regions arranged in one direction; and
an illumination optical system that projects the illumination pattern, which is light having the two-dimensional pattern given thereto by the pattern generating unit, onto the measurement target,
the single-pixel photodetector receives light corresponding to a relative position between the measurement target and the illumination pattern, and outputs the reception signal on the basis of the received light, and
the signal processing unit
generates a two-dimensional image having a different resolution for each of the regions, using the reception signal acquired for each of the regions when the measurement target passes through the region in the illumination pattern.

Thus, the present disclosure has an effect of being capable of generating an image when the measurement target passes through a region among a plurality of regions in the illumination pattern, acquiring images having resolutions that vary in a stepwise manner, and using the images for different inspection items.

Further, the present disclosure exhibits the same effect as the above effect by applying the configuration to the image acquiring method described above.

An image acquiring device of the present disclosure according to the present embodiment is further designed as follows, for example.

An image acquiring device in which,
in each of the regions in the illumination pattern,
a plurality of regions having the sections of different sizes is arranged in such a manner as to be aligned in the direction from a region including large sections to a region including small sections in the direction in which the measurement target moves, and
the signal processing unit
generates a low-resolution two-dimensional image from a signal acquired in the region including the large sections, and
generates a high-resolution two-dimensional image from a signal acquired in the region including the small sections.

Thus, the present disclosure has an effect of being capable of acquiring images having resolutions that vary in a stepwise manner, and using the images for different inspection items.

Further, the present disclosure exhibits the same effect as the above effect by applying the configuration to the image acquiring method described above.

An image acquiring device of the present disclosure according to the present embodiment is further designed as follows, for example.

An image acquiring device in which,
in each of the regions in the illumination pattern,
a plurality of regions having the sections of different sizes is arranged in such a manner as to be aligned in the direction from a region including large sections to a region including small sections in the direction in which the measurement target moves, and
the signal processing unit
generates a low-resolution two-dimensional image from a signal acquired in the region including the large sections,
generates a high-resolution two-dimensional image from both signals acquired in the region including the small sections and in the region including the large sections,
and, when generating the high-resolution two-dimensional image, matches the resolution of the illumination frame corresponding to the signal acquired in the region including the large sections with the resolution of the illumination frame corresponding to the signal acquired in the region including the small sections.

Thus, the present disclosure has an effect of being capable of acquiring images having resolutions that vary in a stepwise manner, and using the images for different inspection items.

Further, the present disclosure exhibits the same effect as the above effect by applying the configuration to the image acquiring method described above.

An image acquiring device of the present disclosure according to the present embodiment is further designed as follows, for example.

An image acquiring device in which
the signal processing unit includes
an image inspecting unit that performs different image inspections on the two-dimensional images having different resolutions.

Thus, the present disclosure has an effect of being capable of providing an image acquiring device that performs image inspections. Also, it is possible to perform an inspection of a different inspection item for each of the generated two-dimensional images.

Further, the present disclosure exhibits the same effects as the above effects by applying the configuration to the image acquiring method described above.

An image acquiring device of the present disclosure according to the present embodiment is further designed as follows, for example.

An image acquiring device in which
at least one inspection item of the image inspections is executed while the measurement target is moving over the illumination pattern.

Thus, the present disclosure has an effect of being capable of outputting an inspection result of at least one inspection item before the measurement target passes over the illumination pattern, and being capable of shortening the inspection time accordingly.

Further, the present disclosure exhibits the same effect as the above effect by applying the configuration to the image acquiring method described above.

### Others and Modifications

In the low-resolution region (first region) 410, a plurality of sections that have the same size have the same luminance as those of the high-resolution region (second region) 420 and may be arranged to form substantially large sections. For example, when 2×2 sections having the identical luminance distribution are arranged, the substantial section size becomes larger. With such a configuration, the low-resolution region (first region) 410 and the high-resolution region (second region) 420 have the same section size, and thus, there is an effect of being able to adopt the same processing conditions for the illumination pattern mask (pattern generating unit) 113A₁ in the entire processing.

The illumination pattern 400 may be divided into three or more regions having different section sizes.

Here, a hardware configuration for achieving the functions of the present disclosure is described.

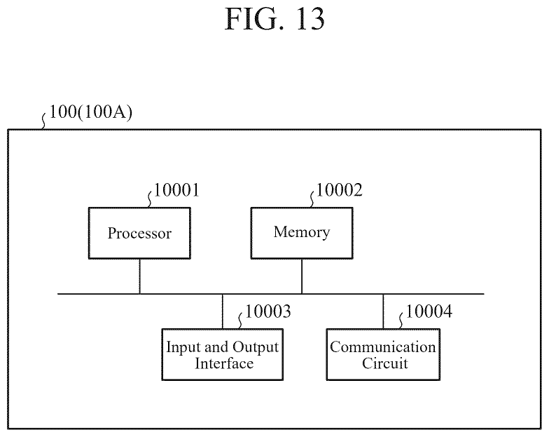

FIG. 13 is a diagram illustrating a first example of a hardware configuration for achieving the functions of a configuration according to the present disclosure.

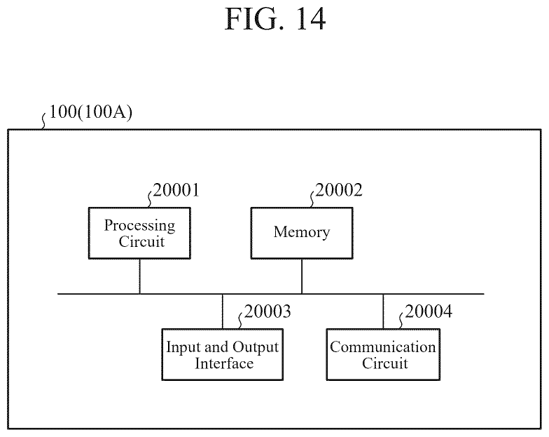

FIG. 14 is a diagram illustrating a second example of a hardware configuration for achieving the functions of a configuration according to the present disclosure.

Each of the illumination controlling units 111, 111A, and 111A₁, and the signal processing units 150 and 150A in the image acquiring devices 100 and 100A of the present disclosure is formed with hardware as illustrated in FIG. 13 or 14.

As illustrated in FIG. 13, each of the illumination controlling units 111, 111A, and 111A₁, and the signal processing units 150 and 150A in the image acquiring devices 100 and 100A includes a processor 10001, a memory 10002, an input and output interface 10003, and a communication circuit 10004, for example.

The processor 10001 and the memory 10002 are mounted on a computer, for example.

The memory 10002 stores a program for causing the computer to function as the illumination controlling unit 111, 111A, or 111A₁, the signal processing unit 150 or 150A, and the control unit (not shown) in the image acquiring device 100 or 100A. As the processor 10001 reads and executes the program stored in the memory 10002, the functions of the illumination controlling unit 111, 111A, or 111A₁, the signal processing unit 150 or 150A, and the control unit (not illustrated) are achieved.

Further, the storage unit (not illustrated) is formed with the memory 10002 or some other memory (not shown).

Also, the communication unit (not shown) is formed with the communication circuit 10004.

The processor 10001 is formed with a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disk such as a compact disc (CD) or a digital versatile disc (DVD), or may be a magnetooptical disk.

The processor 10001, and the memory 10002 or the communication circuit 10004 are connected in such a manner as to be capable of transmitting data to each other. Also, the processor 10001, the memory 10002, and the communication circuit 10004 are connected in such a manner as to be capable of exchanging data with some other hardware via the input and output interface 10003.

Alternatively, the functions of the illumination controlling units 111, 111A, and 111A₁, the signal processing units 150 and 150A, and the control unit (not shown) in the image acquiring devices 100 and 100A may be achieved by a dedicated processing circuit 20001 as illustrated in FIG. 14.

The processing circuit 20001 is formed with a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Also, the storage unit (not illustrated) is formed with a memory 20002 or some other memory (not shown).

The memory 20002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disk such as a compact disc (CD) or a digital versatile disc (DVD), or may be a magnetooptical disk.

Also, the communication unit (not shown) is formed with a communication circuit 20004.

The processing circuit 20001, and the memory 20002 or the communication circuit 20004 are connected in such a manner as to be capable of transmitting data to each other. Also, the processing circuit 20001, the memory 20002, and the communication circuit 20004 are connected in such a manner as to be capable of exchanging data with some other hardware via an input and output interface 20003.

Note that the functions of the illumination controlling units 111, 111A, and 111A₁, the signal processing units 150 and 150A, and the control unit (not shown) in the image acquiring devices 100 and 100A may be achieved by different processing circuits from one another, or may be collectively achieved by a processing circuit.

Alternatively, some of the functions of the illumination controlling units 111, 111A, and 111A₁, the signal processing units 150 and 150A, and the control unit (not shown) in the image acquiring devices 100 and 100A may be achieved by the processor 10001 and the memory 10002, and the remaining functions may be achieved by the processing circuit 20001.

Note that, within the scope of the present disclosure, the embodiments can be freely combined, modifications can be made to any component of each embodiment, or a desired component can be omitted from each embodiment.

### INDUSTRIAL APPLICABILITY

In a case where a two-dimensional image of a measurement target is acquired with a single illumination pattern, and measurement is then performed, the measurement time required for each one measurement target can be shortened by the present disclosure. Thus, the disclosure is suitable for use in a measurement system or the like that irradiates a moving measurement target with an illumination pattern to acquire a two-dimensional image and performs measurement using the acquired two-dimensional image, for example.

### REFERENCE SIGNS LIST

100, 100A: image acquiring device, 110, 110A, 110A₁: illuminating system unit, 111, 111A, 111A₁: illumination controlling unit, 112A: light source unit, 112A₁: monochromatic laser (light source unit), 113A: fixed pattern generating unit (pattern generating unit), 113A₁: illumination pattern mask (pattern generating unit), 114: illumination optical system, 114A₁: illumination lens, 130, 130A: reception unit, 131A: reception optical system, 132A,: single-pixel light detecting unit (single-pixel light detecting device), 150, 150A: signal processing unit, 151A: AD converting unit, 152A: reception signal holding unit, 153A: calibration processing unit, 154A: time synchronizing unit, 155A: illumination frame group holding unit, 156A: illumination frame group synchronizing unit, 157A: image reconstructing unit, 158A: image outputting unit, 159A: image inspecting unit, 160A: inspection result holding unit, 200: measurement target, 250: moving direction of measurement target, 300: object driving unit (object driving device), 400: illumination pattern, 410: low-resolution region (first region), 420: high-resolution region (second region), 430: temporally-synchronized pattern (second region), 500, 500ₘ (m=1, 2, 3 . . . ) (500₁, 500₂, 500₃, 500₄): illumination frame, 600, 600ₙ (n=1, 2, 3 . . . ) (600₁, 600₂): image, 10001: processor, 10002: memory, 10003: input and output interface, 10004: communication circuit, 20001: processing circuit, 20002: memory, 20003: input and output interface, 20004: communication circuit

1. An image acquiring device for acquiring an image of a measurement target moving at a constant speed, comprising:
processing circuitry configured to
output an illumination pattern that is a pattern formed with sections of different sizes for regions among a plurality of regions arranged in one direction;
receive light from the measurement target irradiated with the illumination pattern having been output, via a single-pixel photodetector; and
acquire a reception signal based on the received light, and generate a two-dimensional image of the measurement target for each of the regions on a basis of a change in the acquired reception signal,
wherein, in each of the regions in the illumination pattern, the plurality of regions having the sections of different sizes is arranged in such a manner as to be aligned in a direction from a large section region to a small section region in a direction in which the measurement target moves.

2. The image acquiring device according to claim 1, wherein
the processing circuitry is further configured to
give a two-dimensional pattern to light having been emitted, the two-dimensional pattern being formed with sections of different sizes for regions among a plurality of regions arranged in one direction; and
an illumination optical system to project the illumination pattern, which is light having the two-dimensional pattern, onto the measurement target,
the single-pixel photodetector receives light corresponding to a relative position between the measurement target and the illumination pattern, and outputs the reception signal on a basis of the received light, and
the processing circuitry is configured to
generate a two-dimensional image having a different resolution for each of the regions, using the reception signal acquired for each of the regions when the measurement target passes through the region in the illumination pattern.

3. The image acquiring device according to claim 2, wherein,
the processing circuitry is configured to
generate a low-resolution two-dimensional image from a signal acquired in the large section region, and
generate a high-resolution two-dimensional image from a signal acquired in the small section region.

4. The image acquiring device according to claim 2, wherein,
the processing circuitry is configured to
generate a low-resolution two-dimensional image from a signal acquired in the large section region, and
generate a high-resolution two-dimensional image from both signals acquired in the small section region and in the large section region,
and, when generating the high-resolution two-dimensional image, the processing circuitry is configured to match a resolution of an illumination frame corresponding to the signal acquired in the large section region with a resolution of an illumination frame corresponding to the signal acquired in the small section region.

5. The image acquiring device according to claim 3, wherein
the processing circuitry is configured to
perform different image inspections on the two-dimensional images having different resolutions.

6. The image acquiring device according to claim 5, wherein
at least one inspection item of the image inspections is executed while the measurement target is moving over the illumination pattern.

7. An image acquiring method implemented by an image acquiring device for acquiring an image of a measurement target moving at a constant speed, comprising:
outputting, by the image acquiring device, an illumination pattern that is a pattern formed with sections of different sizes for regions among a plurality of regions arranged in one direction,
receiving, by the image acquiring device, light from the measurement target irradiated with the output illumination pattern, via a single-pixel photodetector, and
acquiring, by the image acquiring device, a reception signal based on the received light, and generates a two-dimensional image of the measurement target for each of the regions on a basis of a change in the acquired reception signal,
wherein, in each of the regions in the illumination pattern, the plurality of regions having the sections of different sizes is arranged in such a manner as to be aligned in a direction from a large section region to a small section region in a direction in which the measurement target moves.
